(19) United States
(12) Patent Application Publication
(10) Pub. No.: US 2005/0141374 A1
(43) Pub. Date: Jun. 30, 2005

(54) Apparatus and method for reproduction from optical disk

(75) Inventors: Naoto Mihara, Yokohama-shi (JP); You Yoshioka, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/017,232

(22) Filed: Dec. 21, 2004

(30) Foreign Application Priority Data
Dec. 25, 2003 (JP) 2003-430602

(51) Int. Cl. G11B 5/09

(52) U.S. Cl. 369/47.28; 369/47.21

(57) ABSTRACT

The present invention includes sync detecting means for generating a flag when the pattern of a phase detection signal is compared with the pattern of a sync pattern model signal and when the patterns match, phase detecting means for dividing a wobble clock in accordance with a predetermined wobble period and generating a flag corresponding to one of the phases of the wobble clock divided in which phase edges in the phase detection signal are concentrated, and control means for using the output flag from the phase detecting means to limit the output range of the sync detecting means and outputting a sync pattern detection flag.

### CROSS-REFERENCE TO RELATED APPLICATIONS

This application is based upon and claims the benefit of priority from prior Japanese Patent Application No. 2003-430602, filed Dec. 25, 2003, the entire contents of which are incorporated herein by reference.

### BACKGROUND OF THE INVENTION

1. Field of the Invention

The present invention relates to an apparatus and method for reproduction from an optical disk in which information recording tracks are subjected to wobble modulation to reproduce information from an optical disk on which sync information and address information are recorded.

2. Description of the Related Art

As is well known, techniques for densely recording information have been promoted in recent years. Optical disks having a recording capacity of no less than 4.7 GB (Giga Bytes) in one layer on one side have been put to practical use.

These optical disks include, for example, a reproduction-exclusive DVD ROM (Digital Versatile Disk Read Only Memory), a rewritable DVD-RAM (Random Access Memory), a DVD-RW (Rewritable), and a recordable DVD-R (Recordable).

Information is recorded on and reproduced from an optical disk of this kind by condensing laser light in an information recording layer formed on a transparent substrate. In this case, the information recording layer of the optical disk has tracks consisting of physical concaves or convexes and formed concentrically with the optical disk. Information is recorded and reproduced along the tracks.

In this case, address information including sync information is recorded on the tracks in order to identify a spatial position on and from which information is recorded and reproduced. A reproducing apparatus reproducing information from such an optical disk first detects sync information. The reproducing apparatus then determines the position of the address information on the result of the detection. The reproducing apparatus then reads the address information.

Here, the sync information and the address information are recorded by slightly wobbling wall surfaces forming the tracks, in a radial direction of the optical disk and utilizing what is called wobble modulation that subjects the wobble to frequency or phase modulation to pattern each of the sync information and address information.

In the conventional detection of the sync information, first, a signal corresponding to a wobble waveform recorded in the optical disk (a wobble signal) is read from the optical disk. A phase detection signal is then generated which represents a modulation status of the wobble signal as a phase difference. The pattern of a signal obtained by binarizing the phase detection signal is then compared with the pattern of a sync pattern model signal already provided. A matching status of these signals is then comprehensively evaluated for a predetermined comparison section.

Alternatively, on the basis of the results of detection of sync information obtained at a specified period, a detection window gate is generated at a time when sync information is assumed to be detected. Then, the reliability of the sync information detected is evaluated on the basis of whether or not sync information is detected within the range of the window gate generated.

However, the conventional means for detecting sync information poses the following problems. When the waveform of the wobble signal loses its shape as a result of noise, a transmission characteristic, or the like, the sync information may not be accurately detected. Conversely, if the address information is similar to the sync information, it may be misdetected as the sync information.

Further, even when the detection window gate is set in order to eliminate the sync information misdetected, the correct sync information cannot be detected if the misdetection pattern of the address information appears at the same period as that of the sync information.

Moreover, in order that the sync information may be detected in a wobble signal the waveform of which has lost its shape, a soft decision may be used instead of employing the decision based on a perfect match with the synch pattern model signal; for example, the soft decision permits mismatches at several positions within the comparison section. In this case, the sync information may be detected before or after the correct sync position depending on how the sync pattern has been deformed.

Jpn. Pat. Appln. KOKAI Publication No. 2000-331430 discloses a mechanism which records a sync auxiliary pattern at a position located a distance before the sync pattern, the distance corresponding to a predetermined section, and which detects, during reproduction, the sync auxiliary pattern to limit the range within which the sync pattern is detected on the basis of the sync auxiliary pattern detected. This mechanism thus reduces the misdetection of the sync pattern at positions other than that of the original sync pattern.

However, Jpn. Pat. Appln. KOKAI Publication No. 2000-331430 requires the sync auxiliary pattern to be recorded on the optical disk. Consequently, it is difficult to put this patent to practical use. Further, if reproduction is carried out using an optical disk reproducing apparatus not having any function for detecting the sync auxiliary pattern, the sync auxiliary pattern is disadvantageously likely to be misdetected as a different pattern.

The present invention is made in view of these circumstances. It is an object of the present invention to provide an apparatus and method for reproduction from an optical disk which apparatus and method enable sync information recorded by wobble modulation to be very reliably detected without recording new information required to detect the sync information.

### BRIEF SUMMARY OF THE INVENTION

An optical disk reproducing apparatus which reproduces information from an optical disk on which sync information and address information are recorded on the basis of a combination of a first wobble signal and a second wobble signal obtained by modulating the first wobble signal so that the first and second wobble signals have opposite phases, according to the invention, comprises: a detecting section which detects particular information on at least one of the sync information and address information in the first and second wobble signals read from the optical disk, to output a detection signal; a phase detecting section which generates a phase detection signal having a polarity corresponding to a modulation status of the first and second wobble signals read from the optical disk; a generating section which generates a signal of a fixed period which synchronizes with phase edges in the address information obtained at the fixed period from the phase detection signal generated by the phase detecting section; and a masking section which makes valid a detection signal output by the detecting section using a timing which synchronizes with the signal generated by the generating section, the masking section making invalid detection signals provided using other timings.

An optical disk reproducing apparatus which reproduces information from an optical disk, according to the invention, comprises: a sync field which consists of first data units forming a sync pattern in which first wobble signals and second wobble signals are alternately arranged at respective particular wobble periods, the second wobble signal being obtained by modulating the first wobble signal so that the first and second wobble signals have opposite phases, and an address field having a portion in which the first and second wobble signals can be arbitrarily arranged at equal wobble periods and having a plurality of second data units configured using the same wobble period as that of the first data units, the address field as a whole forming address information, physical addresses being recorded on the optical disk using a fixed recording length unit including the sync field and the address field, wherein a wobble period constituting the fixed recording length unit of the physical address and the wobble periods of the first and second wobble signals which can be arbitrarily arranged using the second data units are each a multiple of a predetermined wobble period, the apparatus comprising: a phase detecting section which generates a phase detection signal having a polarity corresponding to a modulation status of the first and second wobble signals read from the optical disk; a detecting section which detects a pattern corresponding to a particular pattern in the phase detection signal generated by the phase detecting section; a clock generating section which generates a wobble clock having a period equal to the period of the first and second wobble signals read from the optical disk; a phase detecting section which divides the wobble clock generated by the clock generating section into phases corresponding to the predetermined wobble period and which detects one of the phases of the wobble clock divided in which phase edges of the phase detection signal generated by the phase detecting section are concentrated, the phase detecting section generating a second flag corresponding to the phase detected; and a control section which limits an output range of the first flag output by the detecting section on the basis of the second flag output by the phase detecting section, to output the first flag.

A method for reproduction from an optical disk in which information is reproduced from an optical disk on which sync information and address information are recorded on the basis of a combination of a first wobble signal and a second wobble signal obtained by modulating the first wobble signal so that the first and second wobble signals have opposite phases, according to the invention, comprises: detecting particular information on at least one of the sync information and address information in the first and second wobble signals read from the optical disk, to output a first signal; generating a phase detection signal having a polarity corresponding to a modulation status of the first and second wobble signals read from the optical disk; generating a second signal of a fixed period which synchronizes with phase edges in the address information obtained from the phase detection signal at the fixed period; and making valid the first signal output by the detecting section using a timing which synchronizes with the second signal and making invalid the first signals provided using other timings.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIGS. 1A and 1B are diagrams showing an embodiment of the present invention and illustrating wobbles NPW and IPW;

FIG. 2 is a diagram illustrating a WAP configuration of data recorded on an optical disk according to the embodiment;

FIG. 3 is a diagram illustrating the relationship between a phase detection signal and a bit clock for an address modulation code according to the embodiment;

FIG. 4 is a block diagram illustrating an example of a sync detecting circuit according to the embodiment;

FIG. 5 is a timing chart illustrating an operation performed by the sync detecting circuit according to the embodiment to generate a sync head 4 period flag;

FIG. 6 is a timing chart illustrating an operation performed by the sync detecting circuit if a pattern matching flag is not output;

FIG. 7 is a timing chart illustrating an operation performed by the sync detecting circuit if the pattern matching flag has been output;

FIG. 8 is a diagram illustrating how a sync detection range is limited by generating a window gate according to the embodiment;

FIG. 9 is a diagram illustrating a method for generating a sync head detection flag according to the embodiment;

FIG. 10 is a diagram illustrating how to deal with a situation in which an address modulation signal is detected as a false sync according to the embodiment;

FIG. 11 is a flowchart illustrating an operation of the sync detecting circuit according to the embodiment;

FIG. 12 is a flowchart illustrating an operation performed by the sync detecting circuit according to the embodiment to generate a sync head 4 period flag; and

FIG. 13 is a block diagram illustrating an example of a circuit that detects a head of WDU according to the embodiment.

### DETAILED DESCRIPTION OF THE INVENTION

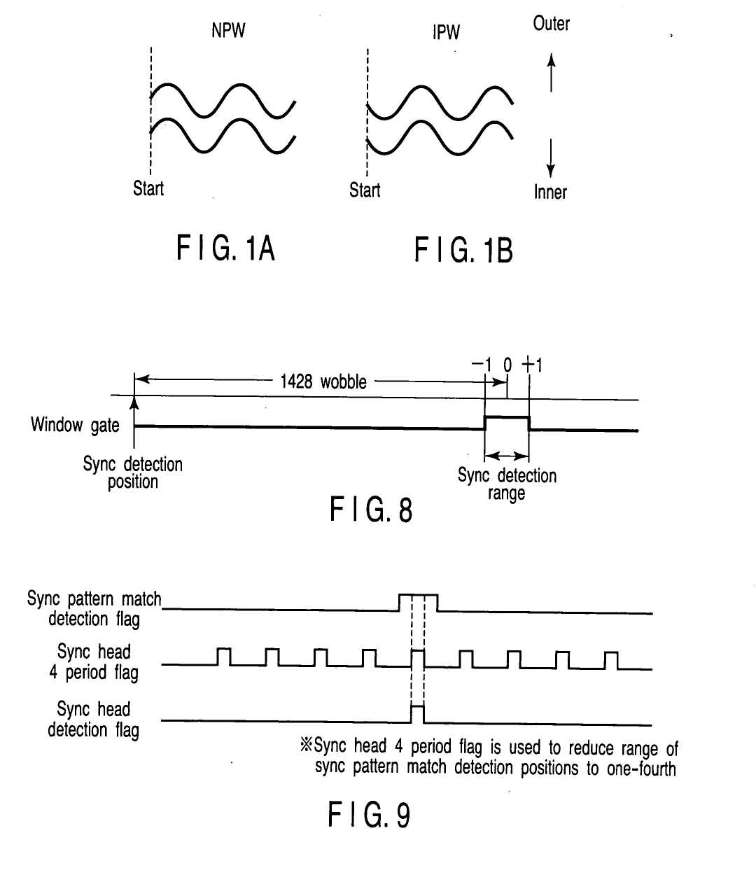

An embodiment of the present invention will be described below in detail with reference to the drawings. First, FIGS. 1A and 1B illustrate a wobble modulation rule. Wobbles NPW and IPW are provided; the wobble NPW is not modulated and has a phase difference from a normal wobble of 0° as shown in FIG. 1A, and the wobble IPW is modulated and has a phase difference from the normal wobble of 180° as shown in FIG. 1B.

NPW and IPW are combined together to represent sync information and address information (an address modulation code). A point at which NPW changes to IPW and a point at which IPW changes to NPW will hereinafter be referred to as phase edges. An optical disk is divided into a plurality of zones in a radial direction in order to make a recording capacity uniform between the inner periphery and outer periphery of the optical disk.

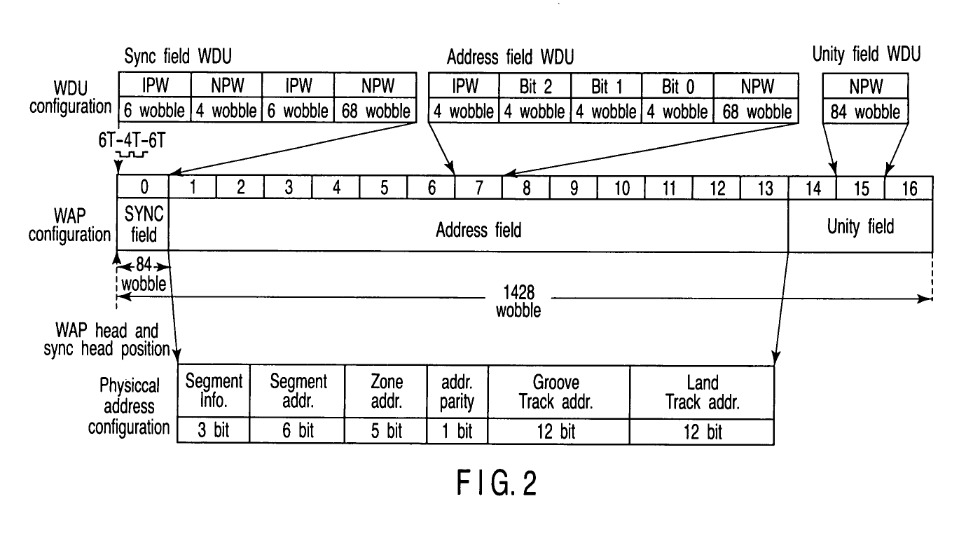

FIG. 2 illustrates the structure of a physical address. One piece of physical address information on a recordable and reproducible optical disk is embedded in each recording length unit called a WAP (Wobble Address in Periodic position).

The physical address information contains “segment information”, a “segment address”, a “zone address”, a “parity address”, a “groove track address”, and a “land track address”.

One WAP is divided into 17 units called WDUs (Wobble Data Units). A head WDU is a “sync field” having sync information. The succeeding 13 WDUs constitute an “address field” having address modulation code information. The remaining three WDUs constitute a “unity field” corresponding to a wobble non-modulation section.

The WDU is composed of 84 wobbles, and the WAP is composed of 1,428 (84×17) wobbles. The sync information and the address modulation code are embedded at fixed relative positions on the optical disk. Accordingly, a timing for reading the address modulation code can be synchronized for each WAP by identifying the sync head position. It is thus very important to detect accurate sync information in the optical disk.

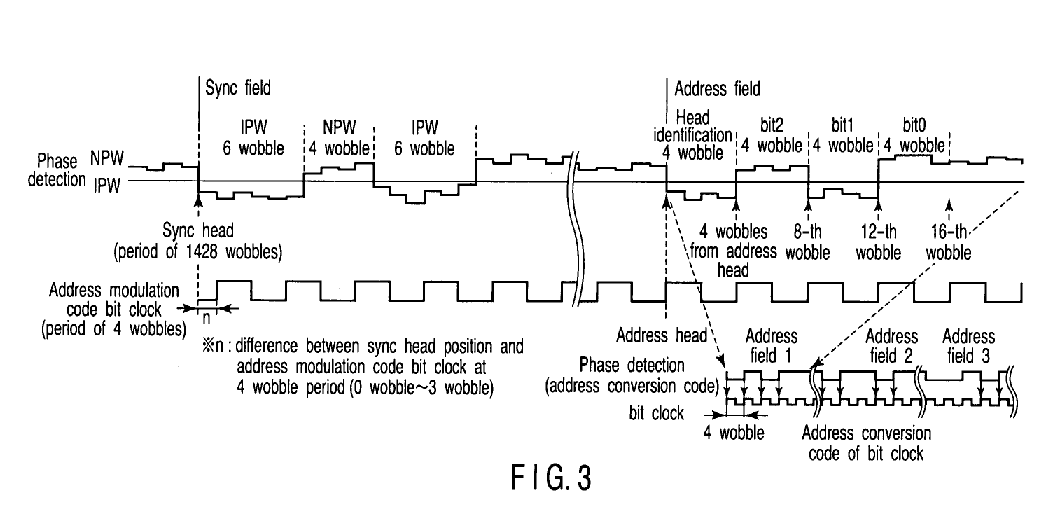

FIG. 3 shows the relationship between the head of a sync information pattern and a bit clock for the address modulation signal. As shown in FIG. 3, according to HD DVD-ARW disk standards, the leading four wobbles in the address field in the WAP constitute IPW used to identify the head. Subsequently, 1 bit of an address is formed of the same code pattern composed of a set of four wobbles, and 3 bits (bit2, bit1, and bit0) of the same code pattern are consecutively provided. The remaining 68 wobbles are composed of NPW.

With this pattern configuration, at most 4 and at least 2 phase edges (points at which the code for the phase changes) are present at a wobble period equal to an integral multiple of four. Further, WDU also has a wobble period (84 wobbles) equal to an integral multiple of four. Accordingly, the bit clock for the address modulation code has a 4 wobble period starting at the head of WAP.

On the other hand, as shown in FIG. 3, the configuration of a sync pattern in the sync field is such that 6 wobbles from the head of WDU constitute IPW, the succeeding 4 wobbles constitute NPW, the succeeding 6 waves constitute IPW, and the remaining 68 wobbles constitute NPW. This sync pattern will hereinafter be represented as “6T-4T-6T”.

In the configuration of the optical disk, the sync field is WDU located at the beginning of WAP. Accordingly, the head phase edge (hereinafter referred to as the “sync head position”) of the sync pattern coincides with the head of WAP. Thus, the period of the sync head position is equal to the period of WAP, that is, a period of 1,428 wobbles. If the sync head position is detected and the detection result deviates from the head of WAP, the synchronization of WAP is carried out so as to correct the deviation.

As shown in FIG. 3, the bit clock period for the address modulation code corresponds to a period of 4 wobbles. Accordingly, the sync head position at the head of WAP maintains the same difference from the bit clock for the address modulation code for all WAPs. “n” shown in FIG. 3 is the fixed difference between the sync head position and the bit clock for the address modulation code.

Although described later in detail, when a phase corresponding to one wobble is assigned to each of 4 wobble periods, it is possible to reduce, to one-fourth, the number of phases in which the sync head position appears relative to the bit clock for the address modulation code.

When each wobble of a phase detection signal is assigned to one of the 4 periods (each phase assigned to one of the 4 periods will hereinafter be referred to as a 4 period phase), the 4 period phase of the bit clock for the address modulation signal is the same as the 4 period phase in which the largest number of phase edges are present when all the phase edges are counted.

Specifically, as shown in FIG. 2, only 4 phase edges are present in the sync pattern in one WAP. In contrast, in the address field with the 13 WDUs, the number of phase edges in the address modulation code is large, that is, 26 to 52. However, immediately after the start of an operation, there is only a small difference in the number of phase edges between the sync pattern and the address modulation code. Accordingly, it should be noted that immediately after the start of an operation, the bit clock for the address modulation code is not accurate.

In this manner, the 4 period phase at the sync head position is determined from the bit clock for the address modulation signal. Then, by using the result of the determination to mask the sync head position determined by a sync pattern match detecting method, it is possible to reduce the range of positions at which the sync head position can appear to one-fourth.

This enables a reduction in the possibility of detecting of a false sync head position different from the sync head position. Consequently, the accuracy of the sync detection is improved. The correct detection of the sync head position leads to the correct synchronization of WAP. As a result, reliable wobble address recording is realized.

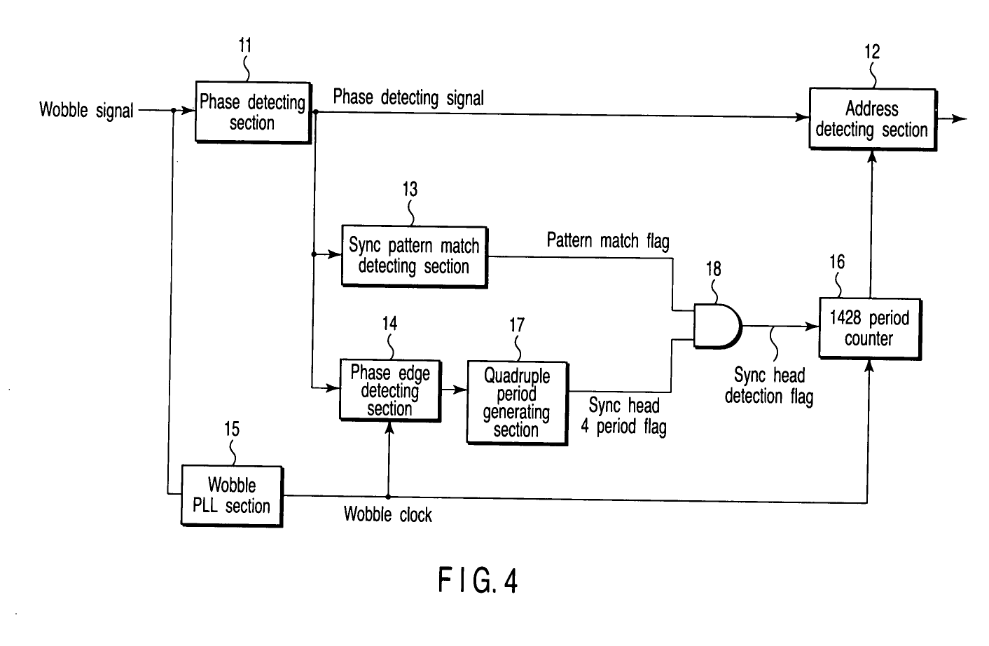

FIG. 4 shows an example of a sync detecting circuit that detects the sync head position using the above technique. First, a wobble signal read from the optical disk is supplied to a phase detecting section 11. The phase detecting section 11 then detects the phase of the wobble signal to convert the signal into a phase detection signal having two values indicative of different levels for NPW and IPW. The phase detection signal output by the phase detecting section 11 is supplied to each of an address detecting section 12, a sync pattern match detecting section 13, and a phase edge detecting section 14.

Further, the wobble signal read from the optical disk is supplied to a wobble PLL (Phase Locked Loop) section 15. The wobble PLL section 15 generates a wobble clock having a period equal to that of the wobble signal. The wobble clock output by the wobble PLL section 15 is supplied to the phase edge detecting section 14 and also supplied to a 1,428 period counter 16 as a count clock.

In this case, the phase edge detecting section 14 detects phase edges (polarity inverting portions) in a phase detection signal input, to generate phase edge detection pulses. The phase edge detecting section 14 also divides the wobble clock input into pieces each corresponding to 4 periods. In this case, the wobble clock input is sequentially divided into sets of 4 period phases A, B, C, D, A, B, C, D, . . . .

The phase edge detecting section 14 checks in which of the 4 period phases A, B, C, and D the phase edge in the phase detection signal has appeared. Specifically, the phase edge detecting section 14 contains four counters corresponding to the 4 period phases A, B, C, and D. For example, when a phase edge detection pulse is detected in the 4 period phase A, the count in the counter corresponding to the 4 period phase A is incremented.

Thus, by comparing the counts in the four counters measured during a predetermined period of time and corresponding to 4 period phases A, B, C, D, it is possible to detect the 4 period phase in which the largest number of phase edges have appeared. Then, if the counter corresponding to the 4 period phase A has the largest count, the phase edge detecting section 14 determines the 4 period phase A to be an edge concentration point. The phase edge detecting section 14 then outputs a signal indicative of the 4 period phase A corresponding to the edge concentration point, to a quadruple period generating section 17.

On the basis of the input signal indicative of the 4 period phase corresponding to the edge concentration point, the quadruple period generating section 17 generates a sync head 4 period flag corresponding to the sync head position.

On the other hand, the sync pattern match detecting section 13 compares the pattern of the phase detection signal input with the sync pattern model signal already provided. When a match is detected, the sync pattern match detecting section 13 generates a pattern match signal.

Then, an AND circuit 18 takes the logical AND of the sync head 4 period flag generated by the quadruple period generating section 17 and the pattern match flag generated by the sync pattern match detecting section 13. The AND circuit 18 then uses the resulting signal as a sync head detection flag to preset the 1,428 period counter 16. That is, before a sync head 4 period flag is generated, even if a pattern match flag has been generated, it is masked by the AND circuit 18. Consequently, the pattern match flag is invalid for the 1,428 period counter 16.

Thus, the 1,428 period counter 16 can circularly count wobble periods (1,428) corresponding to one WAP on the basis of the reliable result of detection of the sync head position. Then, on the basis of an output count from the 1,428 period counter 16, the address detecting section 12 detects whether or not the input phase detection signal belongs to the address field. The address detecting section 12 can thus acquire address information.

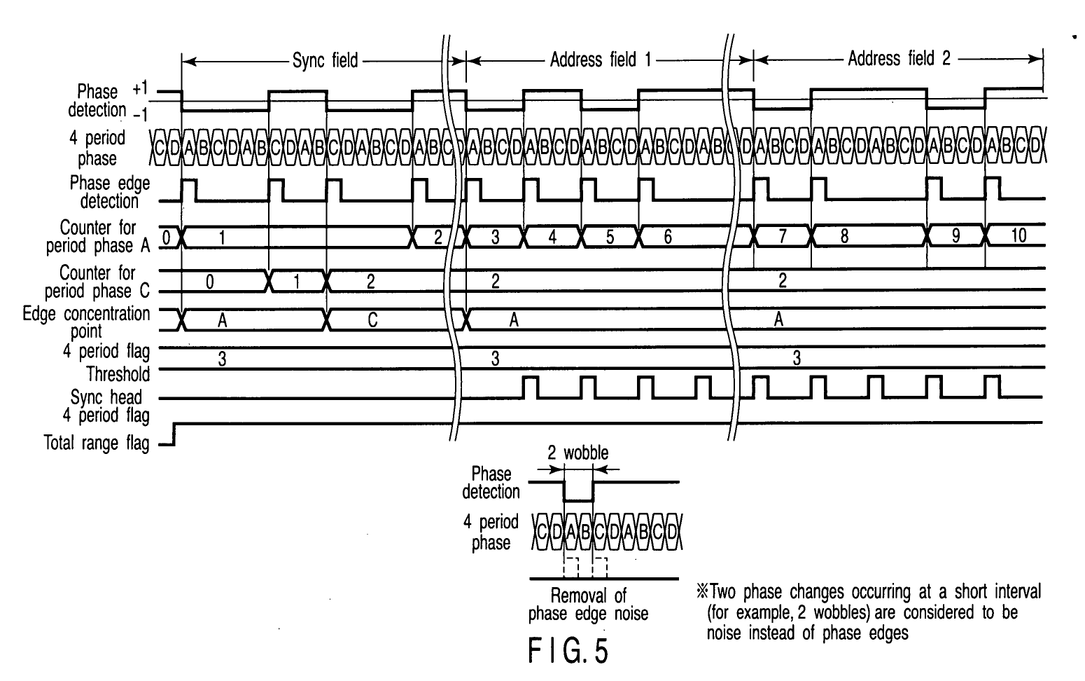

With reference to the timing charts shown in FIG. 5, a detailed description will be given of operations of the sync detecting circuit shown in FIG. 4. First, in order to determine in which of the 4 period phases the phase edge has appeared, the phase edge detecting section 14 in FIG. 4 divides a phase detection signal generated by being read from the optical disk, into pieces each corresponding to a phase composed of 4 periods.

In this case, the wobbles are assigned to the respective 4 period phases A, B, C, D, A, B, C, D, A, . . . The signal may be assigned to the 4 periods by starting the sequential assignment of the wobbles to the 4 period phases at the beginning of operation of the sync detecting circuit or attaching the wobbles to the value of the flywheel counter (1,428 period counter 16 in FIG. 4) used to synchronize WAP.

Then, when phase edges are detected in the phase detection signal, all the phase edges are detected at the same time regardless of whether the phase edge belongs to the sync information or the address modulation code. The phase edge is detected where the code changes between two consecutive wobbles. The phase edge may also be detected when the differential between two consecutive wobbles exceeds a preset threshold.

Further, phase edges normally appear at intervals of at least 4 wobbles. Accordingly, if the interval between two phase edges is short, for example, 2 wobbles, the phases edges may be considered to be noise and thus excluded.

Then, it is determined in which of the 4 period phases A to D the phase edge detected has appeared. The period phase in which the largest number of phase edges have appeared is then determined to be an edge concentration point. To add up the phase edges, it is possible to for example, provide counters for the respective 4 period phases A, B, C, and D which count up the value when a phase edge is detected. FIG. 5 shows the count in the counter for the 4 period phase A and the count in the counter for the 4 period phase C.

The phase edges in the address modulation code in consecutive phase detection signals concentrate in one of the 4 period phases A to D. This edge concentration point is the 4 period phase of the bit clock for the address modulation code.

When the number of phase edges is the same for some of the 4 period phases, it is possible to choose a method for continuing the current 4 period phases or a method for changing to rearranged 4 period phases. The counting of phase edges for determining a new edge concentration point is carried out from the beginning of operation of the sync detecting circuit until the current time.

However, even when all the phase edges appearing during the time from the beginning of operation of the sync detecting circuit until the current time are added up, it is possible to use a method of using an IIR filter or the like to discard a small amount of older results every time a new result is obtained or a method of providing a flag that limits the counting range to count only the phase edges appearing when the flag is valid. It may prepare the reset flag of a total result.

Further, the phase edge detecting section 14 may not only detect the edge concentration point but also determine the degree of phase edge dispersion indicative of the level of the difference between the edge concentration point and the other 4 period phases to output a signal corresponding to the difference.

For example, it is possible to compare the counts in the counters provided in association with the 4 period phases A to D in order to add up the phase edges, to detect, for example, a state in which the edge concentration point far surpasses the other 4 period phases, a state in which another 4 period phase is close to the edge concentration point, or a state in which the phase edges are averagely distributed among the four phases. Then, a determination signal indicative of each state may be output. The degree of phase edge dispersion may be used to impose limitations; for example, the edge concentration point may be output only when it far surpasses the other 4 period phases.

The quadruple period generating section 17 in FIG. 4 is a circuit that determines the 4 period phase at the sync head position from the edge concentration point determined, to generate a sync head 4 period flag. The difference between the 4 period phase in the address modulation code and the 4 period phase at the sync head position is fixed according to optical disk standards. Accordingly, a flag is set at the position of the 4 period phase obtained by correctively shifting the position of the edge concentration point loaded in the quadruple period generating section 17, by an amount corresponding to the difference.

For example, if the difference between the 4 period phase in the address modulation code and the 4 period phase at the sync head position is “2” and the edge concentration point is the 4 period phase A, a sync head 4 period flag is generated at the 4 period phase C.

According to the HD DVD-ARW disk standards, the sync head position and the address modulation code have the same 4 period phase. Accordingly, the sync head 4 period flag is set at the 4 period phase determined to be the edge concentration point.

A sync head 4 period flag is generated for every 4 wobble periods unless the edge concentration point changes to a different 4 period phase. However, when the total number of phase edges is small, for example, immediately after activation, the edge concentration point cannot be accurately determined. Accordingly, the limitation described below is imposed. A threshold (hereinafter referred to as a 4 period flag threshold) is provided for the determination of the edge concentration point. The sync head 4 period flag is kept invalid until the number of phase edges exceeds the 4 period flag threshold.

The 4 period flag threshold may be externally set. In FIG. 5, the 4 period flag threshold is “3”, so that the sync head 4 period flag starts to be output when the counter for the 4 period phase A becomes “4”.

Further, in connection with a timing for allowing the quadruple period generating section 17 to load the edge concentration point, it is possible to choose a method of sequentially loading the result for the totaling of phase edges as an edge concentration point in real time at all times or a method of periodically loading the result at specified time intervals. The above circuit configuration allows the 4 period phase at the sync head position to be determined.

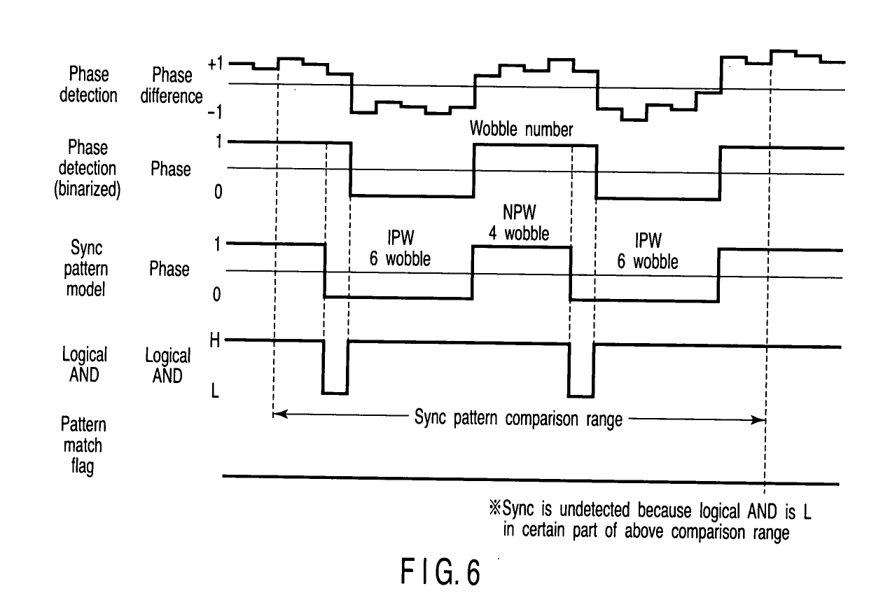

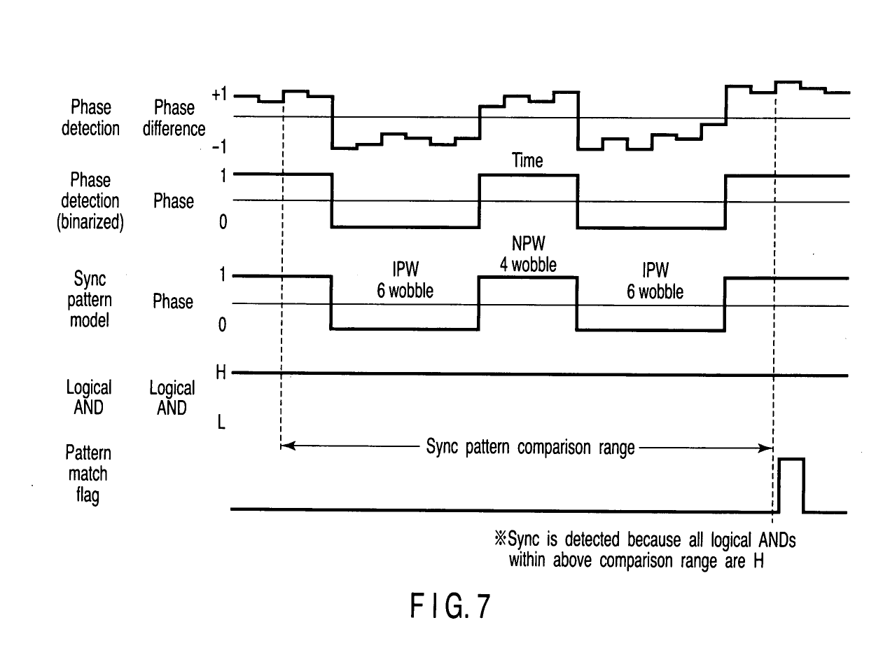

FIGS. 6 and 7 are timing charts illustrating operations of the sync pattern match detecting section 13. FIG. 6 shows an operation performed if the sync information has not been detected. FIG. 7 shows an operation performed if the sync information has been detected.

The phase detecting section 11 detects a wobble signal read from the optical disk, as a phase detection signal. The phase detecting section 11 then uses codes to binarize the phase detection signal. Here, when the polarity of the phase detection signal is positive, the value is “1”. When the polarity of the phase detection signal is negative, the value is “0”.

Then, the sync pattern match detecting section 13 compares the pattern of the binarized phase detection signal with that of the sync pattern model signal. If the patterns match, the sync pattern match detecting section 13 generates a pattern match flag.

The sync pattern model signal is obtained by converting the pattern “6T-4T-6T” into a pattern “0-1-0”. It is possible to choose a perfect decision in which the logical AND of the phase detection signal and the sync pattern model signal is taken for each period of the wobble signal so that when a match is confirmed in all the wobbles in the comparison section, a match in sync pattern is considered to be detected or a soft decision in which a match in sync pattern is considered to be detected when a match is confirmed in at least a specified number of wobbles in the comparison section. FIGS. 6 and 7 show an example of a complete decision Further, it is possible to generate such a window gate as limits the position at which a match in sync pattern is detected to a particular range on the basis of the last sync detected position. For example, as shown in FIG. 8, it is possible to detect a match in sync pattern only between the positions “1428±1” wobble periods away from the last sync detected position.

FIG. 9 shows a method for generating a sync head detection flag. The sync head detection flag is the result of the logical AND of a pattern match flag taken as a result of detection of a match in sync pattern and a sync head 4 period flag determined from the 4 period phase of a phase edge.

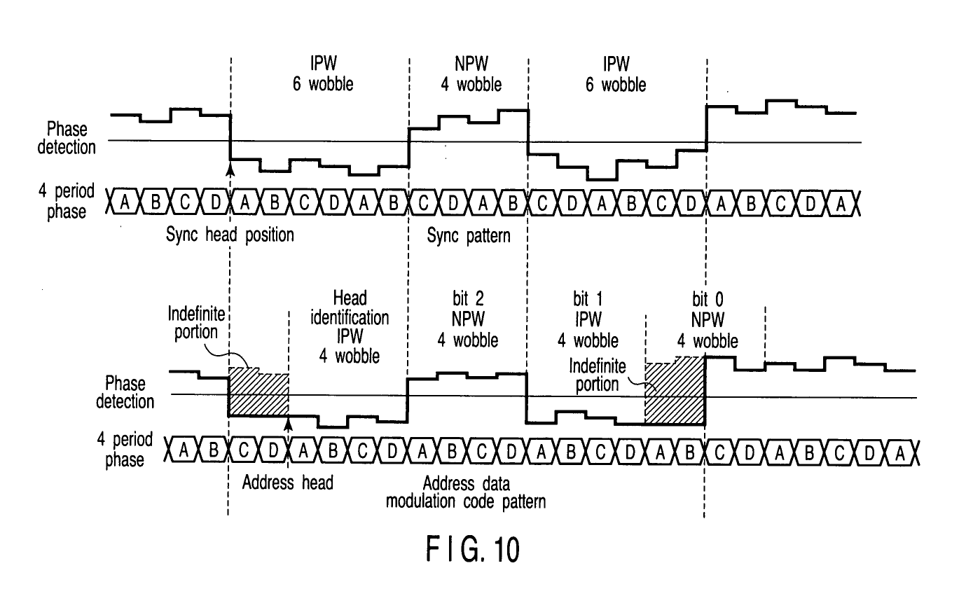

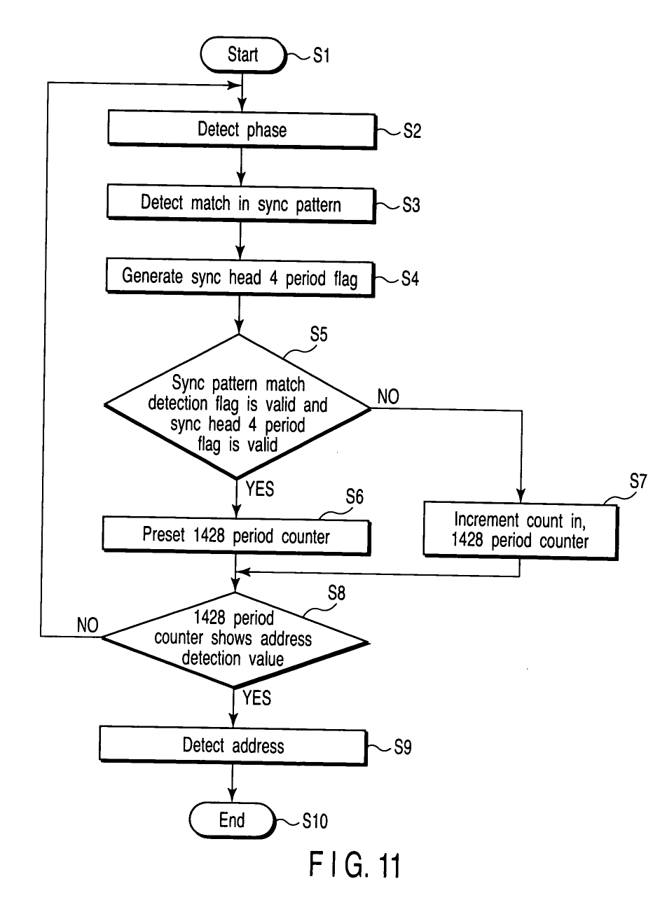

FIG. 10 illustrates the effect of masking of the sync head 4 period flag which effect is produced if the sync pattern match detecting section 13 detects a distorted address modulation signal as a false sync. That is, the sync pattern match detecting section 13 is affected directly by the distortion of the phase detection signal or the like. Further, a distorted address modulation signal may be misdetected as a sync pattern.

For example, as shown in FIG. 10, in an address modulation code of 4 NPWs, 4 IPWs, and 4 NPWs, when two wobbles before a head identification position and two wobbles before bit0 are distorted, the four wobbles corresponding to indefinite portions and being originally NPWs, a match with a sync pattern of 6 IPWs, 4 NPWs, and 6 IPWs in which bit2 is 4 NPWs is determined. As a result, a false sync is detected.

However, when attention is paid to the 4 period phase at the sync head position, the 4 period phase corresponding to the true sync is “A”, whereas the 4 period phase corresponding to the false sync with the distorted address modulation code is “C”. Consequently, it is possible to determine that this is not a sync.

Next, description will be given of a method of using the sync head detection flag to synchronize WAP. With the conventional systems, a flywheel counter that counts up to 1,428 wobbles divides WAP into recording length units. Once the sync pattern match detection flag becomes valid, the counter is preset to a certain value to synchronize WAP.

In contrast, according to the present embodiment, as shown in FIG. 4, the sync head detection flag is obtained by subjecting the pattern match flag and the phase edge concentration point flag (sync head 4 period flag). The sync head detection flag is then used to preset the 1,428 period counter 16 to synchronize WAP.

FIG. 11 is a flowchart schematically showing operations of the sync detecting circuit. Processing is started (step S1). Then, in step S2, a wobble signal is subjected to a phase detecting process to generate a phase detection signal. Then, in step S3, on the basis of the phase detection signal, a process of detecting a match in sync pattern is executed. In step S4, a sync head 4 period flag is generated.

Subsequently, in step S5, it is determined whether or not a state in which both pattern match flag and sync head 4 period flag are valid has been established, that is, whether or not a logical AND of the pattern match flag and sync head 4 period flag has been taken. If the result of the determination is YES, then in step S6, the 1,428 period counter 16 is preset. If the result of the determination is NO, then in step S7, the count in the 1,428 period counter 16 is incremented.

Then, in step S8, it is determined whether or not the count in the 1,428 period counter 16 becomes equal to a value corresponding to the address position. If the result of the determination is NO, the operation returns to the processing in step S2. If the result of the determination is YES, then in step S9, the address is detected to finish the processing (step S10).

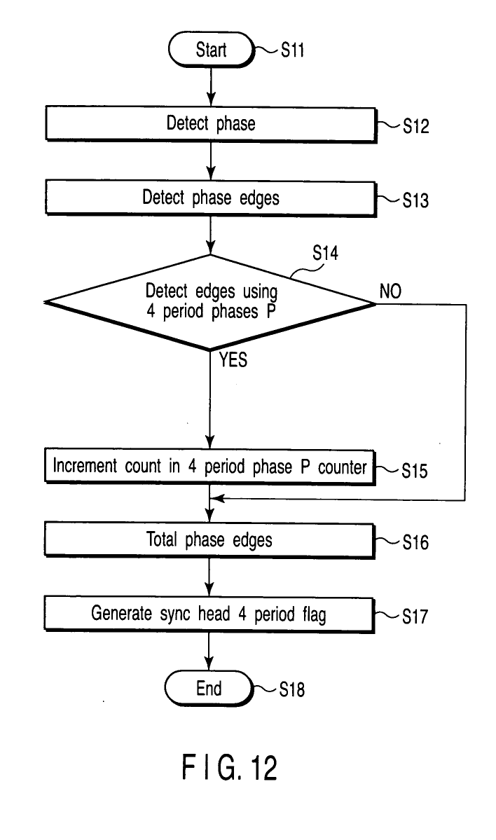

FIG. 12 is a flowchart schematically showing an operation of generating a sync head 4 period flag in step S4. Processing is started (step S11). Then, in step S12, a wobble signal is subjected to a phase detecting process to generate a phase detection signal. In step S13, phase edges are detected in the phase detection signal.

Subsequently, in step S14, it is determined whether or not phase edges were able to be detected in the 4 period phases. If the result of the determination is YES, then in step S15, the counts in the counters provided in association with the 4 period phases A, B, C, and D are incremented.

After step S15 or if the result of the determination in step S14 is NO, the counts in the counters are added up to determine the edge concentration point. In step S17, the 4 period phase at the sync head position is determined to generate a sync head 4 period flag. Then, the processing is finished (step S18).

In the above embodiment, description is given of the reliability in the detection of the sync information. However, the present invention is not limited to the detection of the sync information. The present invention is applicable to, for example, the improvement of the reliability in the detection of the head of WDU.

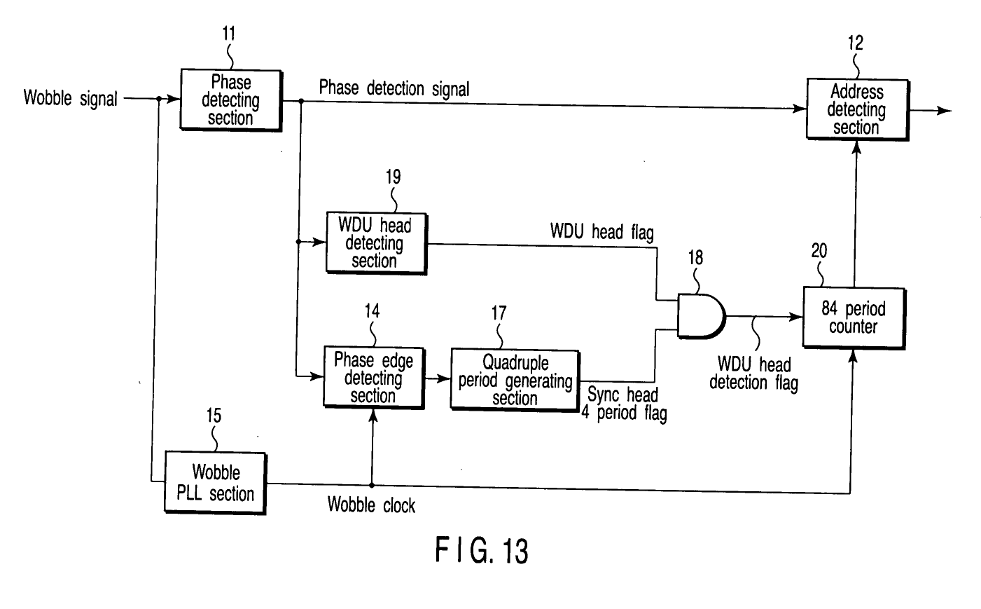

FIG. 13 shows an example of a circuit that detects the head of WDU. FIG. 13 differs from FIG. 4 in that the sync pattern match detecting section 13 is changed to a WDU head detecting section 19 and in that the 1,428 period counter 16 is changed to a 84 period counter 20.

In this case, the WDU head detecting section 19 detects the head of WDU on the basis of the pattern of a phase detection signal input. Specifically, as shown in FIG. 2, a phase detection signal corresponding to NPW of length at least 68 wobbles is present before WDU. A phase detection signal corresponding to IPW of length at least 4 wobbles is present at the head of WDU.

Thus, the WDU head detecting section 19 detects the head of WDU to generate a WDU head flag by detecting a pattern in which a phase detection signal corresponding to IPW of length 4 wobbles appears after a phase detection signal corresponding to NPW of length.

Then, the AND circuit 18 takes the logical AND of the WDU head flag and a sync head 4 period flag output by the quadruple period generating section 17. The resulting signal is a WDU head detection flag that presets the 84 period counter 20. Thus, the 84 period counter 20 can circularly count wobble periods (84) corresponding to one WDU on the basis of the reliable result of detection of the WDU head position.

The present invention is not limited to the above embodiment. In implementation, the components of the embodiment may be embodied by being varied without departing from the spirit of the present invention. Further, various inventions may be formed by appropriately combining together a plurality of components described in the above embodiment. For example, some of the components shown in the embodiment may be omitted. Moreover, components according to different embodiments may be appropriately combined with the components of the above embodiment.

1. An optical disk reproducing apparatus which reproduces information from an optical disk on which sync information and address information are recorded on the basis of a combination of a first wobble signal and a second wobble signal obtained by modulating the first wobble signal so that the first and second wobble signals have opposite phases, the apparatus comprising:
a detecting section which detects particular information on at least one of the sync information and address information in the first and second wobble signals read from the optical disk, to output a detection signal;
a phase detecting section which generates a phase detection signal having a polarity corresponding to a modulation status of the first and second wobble signals read from the optical disk;
a generating section which generates a signal of a fixed period which synchronizes with phase edges in the address information obtained at the fixed period from the phase detection signal generated by the phase detecting section; and
a masking section which makes valid a detection signal output by the detecting section using a timing which synchronizes with the signal generated by the generating section, the masking section making invalid detection signals provided using other timings.

2. The optical disk reproducing apparatus according to claim 1, wherein the detecting section detects the sync information in the first and second wobble signals read from the optical disk to output a sync detection signal, and
the masking section makes valid a sync detection signal output by the detecting section using a timing which synchronizes with the signal generated by the generating section, the masking section making invalid sync detection signals provided using other timings.

3. The optical disk reproducing apparatus according to claim 1, wherein the detecting section detects a head position of the address information in the first and second wobble signals read from the optical disk to output a head detection signal, and
the masking section makes valid a head detection signal output by the head detecting means using a timing which synchronizes with the signal generated by the generating section, the masking section making invalid head detection signals provided using other timings.

4. An optical disk reproducing apparatus which reproduces information from an optical disk comprising:
a sync field which consists of first data units forming a sync pattern in which first wobble signals and second wobble signals are alternately arranged at respective particular wobble periods, the second wobble signal being obtained by modulating the first wobble signal so that the first and second wobble signals have opposite phases, and
an address field having a portion in which the first and second wobble signals can be arbitrarily arranged at equal wobble periods and having a plurality of second data units configured using the same wobble period as that of the first data units, the address field as a whole forming address information,
physical addresses being recorded on the optical disk using a fixed recording length unit including the sync field and the address field,
wherein a wobble period constituting the fixed recording length unit of the physical address and the wobble periods of the first and second wobble signals which can be arbitrarily arranged using the second data units are each a multiple of a predetermined wobble period, the apparatus comprising:
a phase detecting section which generates a phase detection signal having a polarity corresponding to a modulation status of the first and second wobble signals read from the optical disk;
a detecting section which detects a pattern corresponding to a particular pattern in the phase detection signal generated by the phase detecting section;
a clock generating section which generates a wobble clock having a period equal to the period of the first and second wobble signals read from the optical disk;
a phase detecting section which divides the wobble clock generated by the clock generating section into phases corresponding to the predetermined wobble period and which detects one of the phases of the wobble clock divided in which phase edges of the phase detection signal generated by the phase detecting section are concentrated, the phase detecting section generating a second flag corresponding to the phase detected; and
a control section which limits an output range of the first flag output by the detecting section on the basis of the second flag output by the phase detecting section, to output the first flag.

5. The optical disk reproducing apparatus according to claim 4, wherein the detecting section generates the first flag so that a pattern of the phase detection signal corresponds to a pattern of a preset sync pattern model signal, and
the control section limits the output range of the first flag output by the detecting section on the second flag output by the phase detecting section, to output a detection flag for the sync pattern.

6. The optical disk reproducing apparatus according to claim 4, wherein the detecting section detects a pattern corresponding to a head of the second data units in the phase detection signal generated by the phase detecting section, and
the control section limits the output range of the first flag output by the detecting section on the second flag output by the phase detecting section, to output a head detection flag for the second data units.

7. The optical disk reproducing apparatus according to claim 5, further comprising:
a counter which counts the wobble clock generated by the clock generating section and which is preset by the detection flag for the sync pattern output by the limiting section; and
an address detecting section which determines the address field from the phase detection signal generated by the phase detecting section on the basis of a count in the counter, to detect address information.

8. The optical disk reproducing apparatus according to claim 6, further comprising:
a counter which counts the wobble clock generated by the clock generating section and which is preset by the head detection flag for the second data units output by the limiting section; and
an address detecting section which determines the address field from the phase detection signal generated by the phase detecting section on the basis of the count in the counter, to detect address information.

9. The optical disk reproducing apparatus according to claim 7, wherein the phase detecting section totals the number of times the phase edges in the phase detection signal generated by the phase detecting section correspond to the phases of the wobble clock divided in accordance with the predetermined wobble period, to generate the second flag in association with the phase in which the phase edges are concentrated.

10. The optical disk reproducing apparatus according to claim 8, wherein the phase detecting section totals the number of times the phase edges in the phase detection signal generated by the phase detecting section correspond to the phases of the wobble clock divided in accordance with the predetermined wobble period, to generate the second flag in association with the phase in which the phase edges are concentrated.

11. The optical disk reproducing apparatus according to claim 9, wherein the phase detecting section generates the second flag when a preset threshold is exceeded by the number of times the phase edges in the phase detection signal correspond to one of the phases of the wobble clock in which the phase edges are concentrated, the wobble clock being divided in accordance with the predetermined wobble period.

12. The optical disk reproducing apparatus according to claim 10, wherein the phase detecting section generates the second flag when a preset threshold is exceeded by the number of times the phase edges in the phase detection signal correspond to one of the phases of the wobble clock in which the phase edges are concentrated, the wobble clock being divided in accordance with the predetermined wobble period.

13. The optical disk reproducing apparatus according to claim 11, wherein the detecting section starts performing a pattern detecting operation at a sync pattern detection time when the limiting section outputs the detection flag for the sync pattern and continues the pattern detecting operation within a predetermined range including a next sync pattern generation position obtained by counting the wobble clock.

14. A method for reproduction from an optical disk in which information is reproduced from an optical disk on which sync information and address information are recorded on the basis of a combination of a first wobble signal and a second wobble signal obtained by modulating the first wobble signal so that the first and second wobble signals have opposite phases, the method comprising:
detecting particular information on at least one of the sync information and address information in the first and second wobble signals read from the optical disk, to output a first signal;
generating a phase detection signal having a polarity corresponding to a modulation status of the first and second wobble signals read from the optical disk;
generating a second signal of a fixed period which synchronizes with phase edges in the address information obtained from the phase detection signal at the fixed period; and
making valid the first signal output by the detecting section using a timing which synchronizes with the second signal and making invalid the first signals provided using other timings.

15. The method for reproduction from an optical disk according to claim 14, wherein the sync information is detected in the first and second wobble signals read from the optical disk to output a sync detection signal that is the first signal, and
the sync detection signal output by the detecting section using a timing which synchronizes with the second signal is made valid, while the sync detection signals provided using other timings are made invalid.

16. The method for reproduction from an optical disk according to claim 14, wherein a head position of the address information is detected in the first and second wobble signals read from the optical disk to output a head detection signal that is the first signal, and
the head detection signal output by the head detecting means using a timing which synchronizes with the second signal is made valid, while the head detection signals provided using other timings are made invalid.

17. The method for reproduction from an optical disk according to claim 14, in which information is reproduced from an optical disk having:
the sync field which consists of first data units forming a sync pattern in which first wobble signals and second wobble signals are alternately arranged at respective particular wobble periods, the second wobble signal being obtained by modulating the first wobble signal so that the first and second wobble signals have opposite phases, and
the address field having a portion in which the first and second wobble signals can be arbitrarily arranged at equal wobble periods and having a plurality of second data units configured using the same wobble period as that of the first data units, the address field as a whole forming address information,
physical addresses being recorded on the optical disk using a fixed recording length unit including the sync field and the address field,
wherein a wobble period constituting the fixed recording length unit of the physical address and the wobble periods of the first and second wobble signals which can be arbitrarily arranged using the second data units are each a multiple of a predetermined wobble period, the method comprising:
generating a first flag when a pattern of the phase detection signal corresponds to a pattern of a preset sync pattern model signal;
generating a wobble clock having a period equal to the period of the first and second wobble signals read from the optical disk;
dividing the wobble clock into phases corresponding to the predetermined wobble period and detecting one of the phases of the wobble clock divided in which phase edges of the phase detection signal are concentrated, to output a second flag corresponding to the phase detected; and
limiting an output range of the first flag on the basis of the second flag to output the first flag.

18. The method for reproduction from an optical disk according to claim 14, in which information is reproduced from an optical disk comprising:
the sync field which consists of first data units forming a sync pattern in which first wobble signals and second wobble signals are alternately arranged at respective particular wobble periods, the second wobble signal being obtained by modulating the first wobble signal so that the first and second wobble signals have opposite phases, and
the address field having a portion in which the first and second wobble signals can be arbitrarily arranged at equal wobble periods and having a plurality of second data units configured using the same wobble period as that of the first data units, the address field as a whole forming address information,
physical addresses being recorded on the optical disk using a fixed recording length unit including the sync field and the address field,
wherein a wobble period constituting the fixed recording length unit of the physical address and the wobble periods of the first and second wobble signals which can be arbitrarily arranged using the second data units are each a multiple of a predetermined wobble period, the method comprising:
detecting a pattern corresponding to a head of the second data unit in the phase detection signal to output a first flag;
generating a wobble clock having a period equal to the period of the first and second wobble signals read from the optical disk;
dividing the wobble clock into phases corresponding to the predetermined wobble period and detecting one of the phases of the wobble clock divided in which phase edges of the phase detection signal are concentrated, to output a second flag corresponding to the phase detected; and
limiting an output range of the first flag on the basis of the second flag to output the first flag.
